(19) United States
(12) Patent Application Publication
(10) Pub. No.: US 2025/0341192 A1
(43) Pub. Date: Nov. 6, 2025

(54) ASSEMBLY FOR A TURBINE ENGINE

(71) Applicant: SAFRAN NACELLES, GONFREVILLE-L'ORCHER (FR)

(72) Inventors: Bertrand Léon Marie DESJOYEAUX, MOISSY-CRAMAYEL (FR); Philippe AVENEL, MOISSY-CRAMAYEL (FR)

(21) Appl. No.: 18/869,147

(22) PCT Filed: Jun. 7, 2023
(86) PCT No.: PCT/FR2023/050806

§ 371 Date: Nov. 25, 2024

(30) Foreign Application Priority Data
Jun. 14, 2022 (FR) 2205720

(51) Int. Cl. F02K 1/04; F01D 25/24; F01D 25/30; F02K 1/80

(52) U.S. Cl. CPC F02K 1/04; F01D 25/243; F01D 25/30; F02K 1/805

(57) ABSTRACT

An assembly for a turbine engine having a longitudinal axis, including an exhaust cone having an annular wall; an exhaust casing arranged upstream of the exhaust cone; a connection flange arranged longitudinally between the exhaust casing and the exhaust cone, the connection flange having an annular portion, which is fixed to the exhaust casing, and connection tabs extending longitudinally in the downstream direction from the annular portion, the connection tabs being distributed circumferentially around the longitudinal axis, each connection tab being connected to the annular wall of the exhaust cone; and a plurality of sealing members, each sealing member sealing closed a space delimited circumferentially between a first connection tab and a second connection tab which are circumferentially successive.

### CROSS-REFERENCE TO RELATED APPLICATIONS

This application is a US National phase Application of PCT/FR2023/050806 filed Jun. 7, 2023, which claims priority to French Patent Application No. 2205720 filed Jun. 14, 2022, both of which are hereby incorporated by reference in their entirety.

### TECHNICAL FIELD

This description relates to an exhaust assembly for a turbine engine. This description also relates to a turbine engine comprising such an assembly.

### PRIOR ART

Conventionally, as shown in FIG. 1, a turbine engine 10 of the turbofan type having a longitudinal axis comprises, from upstream to downstream in the direction of circulation of gases in turbine engine 10: a fan 12, a low-pressure compressor 14a, a high-pressure compressor 14b, a combustion chamber 16, a high-pressure turbine 18a, a low-pressure turbine 18b, and an exhaust nozzle 20. High-pressure compressor 14b and low-pressure compressor 14a are respectively connected to a high-pressure turbine 18a and a low-pressure turbine 18b by a respective shaft extending in the longitudinal direction of rotation of the shafts of the turbine engine. In the following, orientation qualifiers such as “longitudinal”, “radial”, and “circumferential” are defined in reference to the longitudinal axis X.

The air flow entering the turbine engine is divided, downstream of fan 12, into a primary annular air flow entering an annular flow path 22a referred to as primary, and a secondary annular air flow entering an annular flow path 22b referred to as secondary which surrounds primary annular air flow path 22a. The working parts of low-pressure compressor 14a and high-pressure compressor 14b, combustion chamber 16, and high-pressure turbine 18a and low-pressure turbine 18b are located in primary annular flow path 22a.

An exhaust casing 30 is located directly at the outlet of low-pressure turbine 28b. Exhaust casing 30 comprises a radially inner shell 32 and a radially outer shell 34. An annular space formed between the inner shell and the outer shell forms a portion of the primary flow path 22a at the outlet of low-pressure turbine 18b. The inner shell of the exhaust casing may be made of metal, for example of titanium alloy or an Inconel® type of alloy.

Exhaust nozzle 20, or propelling nozzle, of turbine engine 10 comprises an exhaust assembly which allows optimizing the flow of hot gases exiting the turbine. This assembly may also have the function of absorbing at least some of the noise generated by the interaction of these hot gases with the ambient air and with the flow of cold air from the fan.

This exhaust assembly comprises an exhaust cone 40 which can be seen in FIGS. 1, 2, and 3, which comprises an upstream portion 40a of substantially axisymmetric shape around the longitudinal axis X, and a downstream portion 40b of substantially conical shape along the longitudinal axis X. Upstream portion 40a comprises an upstream annular wall 44.

Upstream annular wall 44 is connected to the downstream end of inner shell 32 of exhaust casing 30 by means of a connection flange 46. Connection flange 46 is made of metal, for example of a titanium alloy or an Inconel® type of alloy. Connection flange 46 comprises an annular portion 47 extending around the longitudinal axis X, from which extend, in the downstream direction, flexible tabs 50 regularly distributed around the circumference. Annular wall 44 of exhaust cone 40 partly surrounds tabs 50 and is connected to each of tabs 50. Such flexible or bendable tabs 50 make it possible to compensate for the differential expansion phenomena which occur between inner shell 32 of exhaust casing 30 and exhaust cone 40, these two elements being made of materials having different thermal expansion coefficients.

In order not to reduce the performance of the turbine engine, it is appropriate to seal off the free spaces 51 formed circumferentially between each pair of circumferentially adjacent tabs 50 and longitudinally between the downstream portion of annular flange 47 and upstream annular wall 44 of exhaust cone 40 in order to prevent the flow of hot gases from leaking radially inwards.

It is therefore desirable to find a sealing solution which adds little weight to the exhaust assembly, and provides thermoelastic flexibility compatible with the thermomechanical deformations of the exhaust assembly, in particular those of tabs 50 and upstream annular wall 44.

### SUMMARY

An assembly for a turbine engine having a longitudinal axis is proposed, comprising:
an exhaust cone comprising an annular wall,
an exhaust casing arranged upstream of the exhaust cone, and
a connection flange arranged longitudinally between the exhaust casing and the exhaust cone, the connection flange comprising an annular portion which is fixed to the exhaust casing and connection tabs extending longitudinally downstream from the annular portion, the connection tabs being distributed circumferentially around the longitudinal axis, each connection tab being connected to the annular wall of the exhaust cone,
a plurality of sealing members, each sealing member sealing closed a space circumferentially delimited between a first connection tab and a second connection tab which are circumferentially successive and longitudinally delimited between the annular portion of the connection flange and the annular wall of the exhaust cone, each sealing member comprising an external plate adapted to be partly applied in the radial direction against a radially outer face of each among the first and second connection tabs.

Each sealing member allows locally sealing off one of the spaces formed circumferentially between two circumferentially successive connection tabs. Such a set of sealing members has a reduced mass compared to a single annular sealing member positioned between the upstream casing shell and the annular wall of the exhaust cone so as to cover all the connection tabs and thereby seal off all the free spaces.

Each sealing member may have at least one degree of freedom of movement in the circumferential direction between the two adjacent tabs, in order to be able to slide when the two tabs move further apart or closer together. Each sealing member may have a degree of freedom in the longitudinal direction relative to the adjacent connection tabs, to the annular portion of the upstream flange, and to the upstream wall of the exhaust cone, in order to be able to slide relative to the neighboring parts during thermomechanical deformations of said parts.

Furthermore, during operation of the turbine engine, the pressure of the hot gases circulating in the turbine engine may be higher radially externally to the assembly than radially internally. Thus, due to this pressure difference, a radially inward force is exerted on the external plate of each sealing member, keeping the latter pressing in the radial direction against the radially outer face of the first connection tab and second connection tab, thus providing a better seal for the corresponding space. Also, each sealing member may comprise an external plate which is partly applied in the radial direction against a radially outer face of each of the first and second connection tabs.

The annular portion of the connection flange may comprise a radial annular wall and a longitudinal annular wall. The longitudinal annular wall may extend longitudinally downstream from the radial annular wall, in particular from a radially outer end of the radial annular wall. Each connection tab may extend longitudinally downstream from the longitudinal annular wall.

The radial annular wall may be fixed to the exhaust casing, in particular to an inner shell of the exhaust casing, in particular by screwing.

The connection tabs may be distributed regularly around the longitudinal axis.

The exhaust cone may comprise an upstream portion of substantially axisymmetric shape around the longitudinal axis and a downstream portion of conical shape along the longitudinal axis with a cross-section that decreases in the downstream direction. The upstream portion may comprise an outer annular wall for the flow of a primary air flow and an annular chamber arranged radially inside the outer annular wall. The annular chamber may comprise an inner annular wall arranged radially inside the outer annular wall of the exhaust cone. Said annular wall of the exhaust cone may be one among the outer annular wall and the inner annular wall. Said annular wall of the exhaust cone may be radially facing a downstream end portion of each of the connection tabs. Said annular wall of the exhaust cone may be arranged radially internally or radially externally to a downstream end portion of each of the connection tabs. In particular, the annular wall of the exhaust cone may surround a downstream end portion of each of the connection tabs. Said annular wall of the exhaust cone may be made of a ceramic matrix composite material.

Each sealing member may in particular be without any attachment relative to the corresponding first and second connection tabs. This allows freedom of movement of the sealing member relative to the first connection tab and second connection tab when they expand thermally during operation of the turbine engine. This makes it possible to reduce or even eliminate the stresses induced in the attachment tabs.

The external plate may comprise an external sealing wall, a first external side tab, and a second external side tab, the external sealing wall being arranged circumferentially between the first and second connection tabs, the first external side tab and the second external side tab respectively extending circumferentially from a first circumferential end and a second circumferential end of the external sealing wall which are circumferentially opposite one another, the first external side tab and the second external side tab each being, in whole or in part, applied in the radial direction respectively against the radially outer face of the first connection tab and the radially outer face of the second connection tab.

The external plate may be made of metal. The external sealing wall may participate in sealing closed said space. The external sealing wall may have a generally trapezoidal shape that is coincident with the trapezoidal shape of the space sealed off by the sealing member.

The external plate may comprise an external upstream tab which extends longitudinally upstream from the external sealing wall, the external upstream tab being applied, in whole or in part, in the radial direction against the annular portion of the connection flange.

The external plate of each sealing member is also kept applied in the radial direction against the radially outer face of the annular portion of the connection flange, again enabling a better sealing of the corresponding space. The external upstream tab may be connected to the annular portion of the connection flange by mechanical means (screwing, welding in particular).

Each sealing member may comprise an internal plate, the internal plate being connected to the external plate, the internal plate comprising an internal sealing wall arranged circumferentially between the first connection tab and the second connection tab, and an internal downstream tab which extends longitudinally downstream from the internal sealing wall.

According to a first aspect, each sealing member may comprise a seal. The seal may bear against the annular wall of the exhaust cone. The seal may comprise at least a first portion which is positioned in the radial direction between the internal downstream tab of the internal plate and the annular wall of the exhaust cone. The seal may be a metal, fibrous, or ceramic (CMC) braid. Such a seal is thus resistant to high temperatures.

This allows improving the sealing radially between the sealing member and the annular wall of the exhaust cone. In addition, a simple radial abutment of the first portion of the seal against the annular wall of the exhaust cone reduces or even prevents the generation of mechanical stresses in the annular wall of the exhaust cone. The internal plate may be made of metal. The internal sealing wall may participate in sealing closed said space. The internal sealing wall may have a generally trapezoidal shape which is coincident with the trapezoidal shape of the space sealed off by the sealing member. The first portion of the seal may be inserted, preferably clamped, in the radial direction between the internal downstream tab and a radially inner or outer face of the annular wall of the exhaust cone. The first portion of the seal may be coincident with a downstream end portion of the seal. The first portion of the seal may comprise a downstream arm of the seal. The seal may be made of a material resistant to high temperatures.

The seal may comprise a second portion that is different from the first portion, the second portion of the seal being arranged radially between the external sealing wall and the internal sealing wall. Such an arrangement allows the seal to be fixed to the external plate and the internal plate.

The second portion of the seal may extend circumferentially from the first connection tab to the second connection tab and longitudinally from the annular portion of the connection flange to an upstream end portion of the annular wall of the exhaust cone.

The seal may comprise a first external side tab and a second external side tab which each extend circumferentially from a respective first circumferential end and second circumferential end of the second portion of the seal which are opposite one another, the first external side tab of the seal being radially interposed, preferably clamped, between the first connection tab and the first external side tab of the external plate, and the second external side tab of the seal being radially interposed and clamped between the second connection tab and the second external side tab of the external plate.

This allows improving the circumferential sealing between the sealing member and each among the first connection tab and the second connection tab. The second portion of the seal may be generally flat. The second portion of the seal may comprise one or more holes adapted to allow a connecting means to pass through between the external sealing wall and the internal sealing wall. The connecting means may be a mechanical means (screwing, riveting, welding in particular). This allows the attachment between the external plate and the internal plate.

The internal plate may comprise a first internal side tab and a second internal side tab, the first internal side tab and the second internal side tab extending circumferentially from a respective first circumferential end and second circumferential end of the internal sealing wall which are circumferentially opposite one another, the first internal side tab and the second internal side tab each being applied, in whole or in part, in the radial direction respectively against a radially inner face of the first connection tab and a radially inner face of the second connection tab.

The seal may comprise a first internal side tab and a second internal side tab each extending circumferentially from a respective first circumferential end and second circumferential end of the second portion of the seal which are opposite one another, the first internal side tab of the seal being radially interposed, preferably clamped, between the first connection tab and the first internal side tab of the internal plate, and the second internal side tab of the seal being radially interposed, preferably clamped, between the second connection tab and the second internal side tab of the internal plate. This allows further improving the circumferential sealing between the sealing member and each among the first connection tab and the second connection tab.

The seal may comprise an upstream tab extending longitudinally from an upstream end of the second portion of the seal, the external upstream tab of the seal being radially interposed, preferably clamped, between the annular portion of the connection flange and the external upstream tab of the external plate. This allows further improving the sealing longitudinally between the sealing member and the connection flange.

The external sealing wall and the internal sealing wall may cooperate to form a first radial face and a second radial face. The second portion of the seal may comprise a first side arm and a second side arm each being connected at a downstream end to the first portion of the seal, the first arm of the seal being interposed, preferably clamped, in the circumferential direction between the first radial face and the first connection tab and the second arm of the seal being interposed, preferably clamped, in the circumferential direction between the second radial face and the second connection tab.

This allows improving the circumferential sealing between the sealing member and each among the first and second connection tabs. The first radial face and the second radial face may be circumferentially opposite one another.

The external sealing wall and the internal sealing wall may each comprise a central portion, and a first circumferential end portion and a second circumferential end portion which are opposite each other in the circumferential direction, the central portion of the external sealing wall bearing radially against the central portion of the internal sealing wall, the first radial face being formed by a radial shoulder connecting the central portion of the external sealing wall to the first circumferential end portion of the external sealing wall and/or by a radial shoulder connecting the central portion of the internal sealing wall to the first circumferential end portion of the internal sealing wall, the second radial face being formed by a radial shoulder connecting the central portion of the external sealing wall to the second circumferential end portion of the external sealing wall and/or by a radial shoulder connecting the central portion of the internal sealing wall to the second end portion of the internal sealing wall.

The first arm may be arranged radially between the first circumferential end portion of the external sealing wall and the first circumferential end portion of the internal sealing wall, the second arm being arranged radially between the second circumferential end portion of the external sealing wall and the second circumferential end portion of the internal sealing wall.

The first arm may be radially interposed, preferably clamped, between the first circumferential end portion of the external sealing wall and the first circumferential end portion of the internal sealing wall. The second arm may be radially interposed, preferably clamped, between the second circumferential end portion of the external sealing wall and the second circumferential end portion of the internal sealing wall.

The central portion may be arranged circumferentially between the first circumferential end portion and the second circumferential end portion.

The external sealing wall and the internal sealing wall may cooperate to form an upstream radial face. The second portion of the seal may comprise an upstream arm, the first arm and the second arm each being connected at an upstream end to the upstream arm, the upstream arm of the second portion of the seal being interposed, preferably clamped, in the longitudinal direction between the upstream radial face and the annular portion of the connection flange. This allows improving the sealing longitudinally between the sealing member and the connection flange.

The external sealing wall and the internal sealing wall may each comprise a central portion and an upstream end portion, the central portion of the external sealing wall bearing radially against the central portion of the internal sealing wall; the upstream radial face is formed by a radial shoulder connecting the central portion of the external sealing wall to the upstream end portion of the external sealing wall and/or by a radial shoulder connecting the central portion of the internal sealing wall to the upstream end portion of the internal sealing wall.

The upstream arm of the seal may be arranged radially between the upstream end portion of the external sealing wall and the upstream end portion of the internal sealing wall. The upstream arm of the second portion of the seal may be radially interposed, preferably clamped, between the upstream end portion of the external sealing wall and the upstream end portion of the internal sealing wall.

The central portion of the external sealing wall and the central portion of the internal sealing wall may be connected to each other by mechanical means or by a one-piece connection. One-piece connection is understood to mean that the central portion of the external sealing wall and the central portion of the internal sealing wall may be formed as an integral unit. The external plate and the internal plate may form a unit assembly. Alternatively, the mechanical means may be welding, or a screw/nut or rivet attachment.

The external sealing wall and the internal sealing wall may be connected by a connecting piece arranged radially between the internal sealing wall and the external sealing wall, the first radial face, the second radial face, and, where appropriate, the upstream radial face, being formed by the connecting piece. The external sealing wall and the internal sealing wall may be connected to the connecting piece by mechanical means or by a one-piece connection. For example, the internal plate and the external plate may be made in one piece by additive manufacturing.

According to a second aspect, the sealing member may be without a seal.

The external plate may comprise an external downstream tab which extends longitudinally downstream from the external sealing wall, the external downstream tab being applied, in whole or in part, in the radial direction against the annular wall of the exhaust cone. The radial abutment between the external downstream tab and the annular wall ensures the sealing between the sealing member and the annular wall of the exhaust cone. The external downstream tab curves into a radially outward and longitudinally upstream fold relative to the external sealing wall. This allows improving the sealing between the sealing member and the annular wall of the exhaust cone.

The external plate may comprise a radial lip that extends radially outwards from the external sealing wall. The radial lip may bear in the longitudinal direction against an upstream end of the annular wall of the exhaust cone. This allows further improving the sealing between the sealing member and the annular wall of the exhaust cone.

The external plate may comprise one or more hooks for connection to the connection flange and/or to the adjacent connection tabs. Each hook may extend radially inwardly from the external plate. The external plate may comprise an upstream hook engaged with the annular portion of the connection flange, in particular with the longitudinal annular wall. The external plate may comprise two side hooks, each side hook being engaged with one of the adjacent connection tabs.

Alternatively, the sealing member may comprise an internal plate secured to the external plate, and the internal plate may comprise one or more tabs for connecting the external plate to the connection flange and/or to the adjacent connection tabs. The internal plate may comprise an internal upstream tab, the annular portion of the connection flange being interposed radially between the external upstream tab and the internal upstream tab. In other words, the internal upstream tab may be applied radially against the radially inner face of the annular portion of the connection flange. The internal plate may comprise a first internal side tab and a second internal side tab which are circumferentially opposite one another. The first connection tab may be radially interposed between the first external side tab and the first internal side tab. The second connection tab may be radially interposed between the second external side tab and the second internal side tab. In other words, the first internal side tab and the second internal side tab may be respectively applied radially against the radially inner face of the first connection tab and the second connection tab.

The internal plate and the external plate may be connected to one another by mechanical means or by a one-piece connection. One-piece connection is understood to mean that the internal plate and the external plate may be formed as an integral unit. For example, the internal plate and the external plate may be made in one piece by additive manufacturing. The external plate and the internal plate may form a unit assembly. The mechanical means may be welding, or a screw/nut or rivet attachment.

A turbine engine comprising an assembly as described above is also proposed.

### BRIEF DESCRIPTION OF DRAWINGS

Other features, details and advantages will become apparent upon reading the detailed description below, and upon analyzing the appended drawings, in which:

FIG. 1 is a partial schematic half-section view in a longitudinal section plane of a turbine engine having a longitudinal axis of the prior art;

FIG. 2 is a partial schematic perspective view of an exhaust assembly of the turbine engine of FIG. 1;

FIG. 3 is a larger-scale schematic perspective view of an upstream end portion of the exhaust assembly of FIG. 2;

FIG. 4 is a partial schematic perspective view of an exhaust assembly according to the present description;

FIG. 5 is a schematic perspective view of a sealing member used in the exhaust assembly of FIG. 4 according to a first embodiment;

FIG. 6 is a schematic cross-section view in a longitudinal section plane of the sealing member of FIG. 5;

FIG. 7 is a schematic cross-section view in a section plane perpendicular to the longitudinal axis of the sealing member of FIG. 5;

FIG. 8 is an exploded schematic perspective view of the sealing member of FIG. 5;

FIG. 9 is a schematic perspective view of a sealing member used in the exhaust assembly of FIG. 4 according to a first variant of a second embodiment;

FIG. 10 is a schematic cross-section view in a longitudinal section plane of the sealing member of FIG. 9;

FIG. 11 is a schematic cross-section view in a section plane perpendicular to the longitudinal axis of the sealing member of FIG. 9;

FIG. 12 is an exploded schematic perspective view of the sealing member of FIG. 9;

FIG. 13 is an exploded schematic perspective view of a sealing member used in the exhaust assembly of FIG. 4 according to a second variant of the second embodiment;

FIG. 14 is a partial schematic perspective view of a sealing member used in the exhaust assembly of FIG. 4 according to a third variant of the second embodiment;

FIG. 15 includes FIGS. 15a, 15b, and 15c which each represent a schematic cross-section view of a sealing member used in the exhaust assembly of FIG. 4 in a respective variant of a third embodiment;

FIG. 16 includes FIG. 16a which is a schematic perspective view of the sealing member of FIG. 15a, and FIG. 16b which is a schematic perspective view of a fourth variant of the sealing member according to the third embodiment.

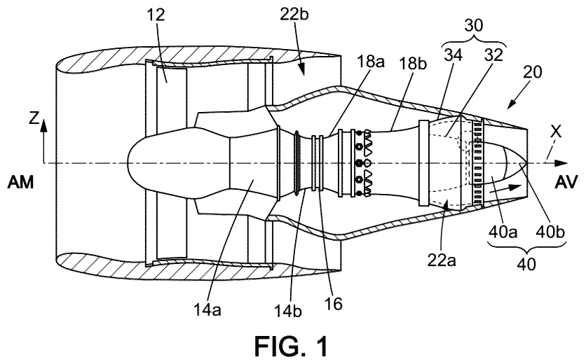

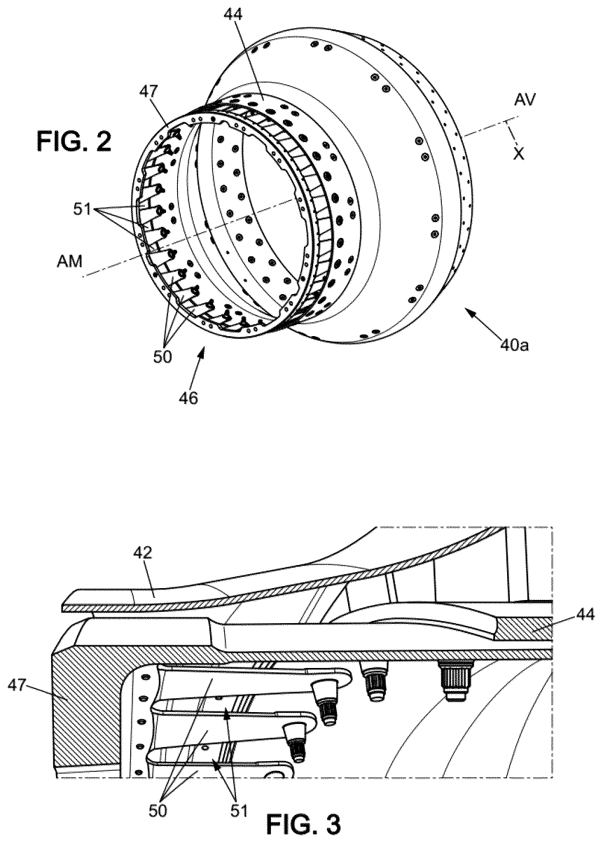

### DESCRIPTION OF EMBODIMENTS

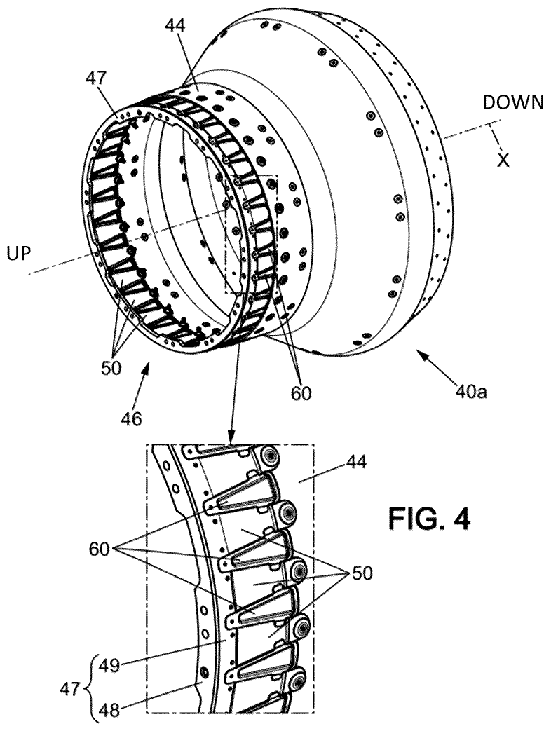

Reference is now made to FIG. 4. FIG. 4 represents an exhaust assembly for a turbine engine having a longitudinal axis X. In the following, orientation qualifiers such as “longitudinal”, “radial”, or “circumferential” are defined in reference to the longitudinal axis X. The relative qualifiers “upstream” and “downstream” are defined with respect to each other in relation to the flow of gases from upstream (UP) to downstream (DOWN) along the longitudinal axis X in the turbine engine.

The assembly firstly comprises an exhaust cone 40. Exhaust cone 40 comprises an upstream portion 40a of substantially axisymmetric shape around the longitudinal axis X, and a downstream portion (not shown) of conical shape along the longitudinal axis X with its cross-section decreasing in the downstream direction. Upstream portion 40a may be surrounded by an outer annular wall (not shown) for the flow of a primary air flow. Upstream portion 40a comprises an inner annular wall 44. Inner annular wall 44 and the outer annular wall of exhaust cone 40 may each be made of a ceramic matrix composite material. Such a material has a low density and thus allows reducing the mass of the assembly.

The assembly may comprise a turbine exhaust casing (not shown). The exhaust casing is arranged upstream of exhaust cone 40. The exhaust casing comprises in particular an inner shell.

The assembly also comprises a connection flange 46 arranged longitudinally between the exhaust casing and exhaust cone 40. Connection flange 46 comprises an annular portion 47 which is fixed to the exhaust casing. In particular, annular portion 47 of connection flange 46 comprises a radial annular wall 48 and a longitudinal annular wall 49. Longitudinal annular wall 49 extends longitudinally downstream from a radially outer end of radial annular wall 48. Radial annular wall 48 is intended to be fixed to the inner shell of the exhaust casing by screwing.

Connection flange 46 also comprises connection tabs 50. Each connection tab 50 extends downstream from longitudinal annular wall 49 of annular portion 47. Connection tabs 50 are distributed circumferentially around the longitudinal axis X. Here, connection tabs 50 are regularly distributed around the longitudinal axis X. Each connection tab 50 is further connected to inner annular wall 44 of exhaust cone 40 by screwing. To do so, inner annular wall 44 of exhaust cone 40 surrounds a downstream end portion of each of connection tabs 50.

A plurality of free spaces is thus defined. Each space is circumferentially delimited between a first connection tab 50 and a second connection tab 50 which are circumferentially successive, and longitudinally between annular portion 47 of connection flange 46 and the annular wall of exhaust cone 40.

Each connection tab 50 may have a shape such that the dimension in the circumferential direction is constant, from where it connects to annular portion 49 to at or near where it connects to inner annular wall 44, or such that the dimension in the circumferential direction of an upstream end portion of connection tab 50 is greater than the dimension in the circumferential direction of a downstream end portion of connection tab 50. In other words, the dimension in the circumferential direction of each connection tab 50 may narrow longitudinally in the downstream direction. Each space formed between two successive connection tabs 50 then has a trapezoidal shape in which the bases (i.e. the parallel sides) are spaced apart longitudinally. The small base of the trapezoidal shape of each space is coincident with a downstream end portion of annular portion 49 of the connection flange 46 which is located circumferentially between two circumferentially successive connection tabs 50. The large base of the trapezoidal shape of each space is coincident with an upstream end portion of the annular wall of exhaust cone 40 which is located circumferentially between two circumferentially successive connection tabs 50.

Finally, the assembly comprises a plurality of sealing members 60. Each sealing member 60 seals off a corresponding space as described above. Each sealing member 60 therefore allows locally sealing off one of the spaces formed circumferentially by two circumferentially successive connection tabs 50. This allows reducing the mass of the assembly in comparison to using an annular crown which surrounds all connection tabs 50 in order to seal off all the free spaces and which therefore has segments that do not contribute to the sealing.

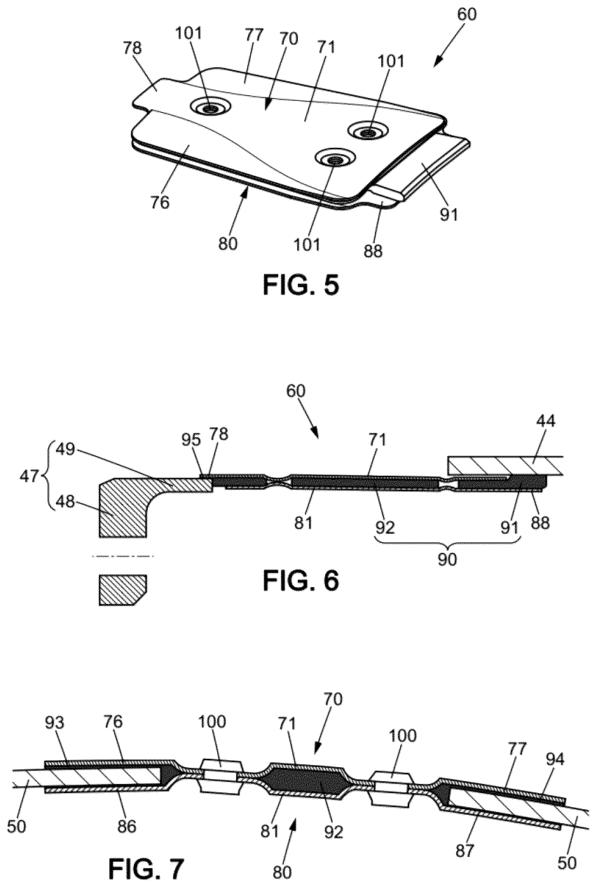

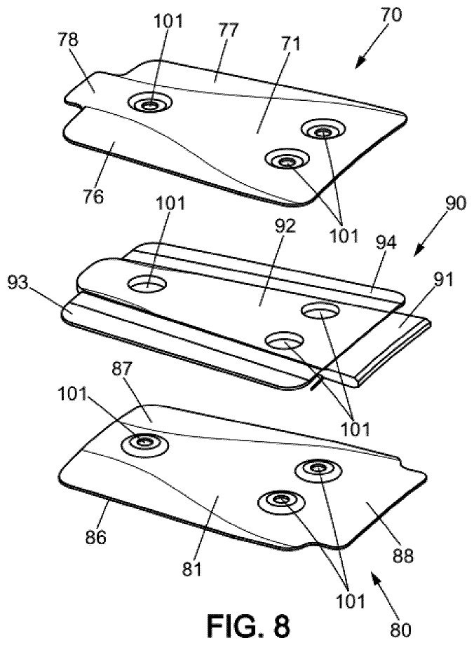

In the following, a sealing member 60 according to a first embodiment is described in more detail with reference to FIGS. 5 to 8.

Sealing member 60 firstly comprises an external plate 70. External plate 70 may be made of metal. External plate 70 comprises an external sealing wall 71. External sealing wall 71 is arranged circumferentially between first connection tab 50 and second connection tab 50 which surround sealing member 60. External sealing wall 71 therefore participates in sealing closed the free space formed circumferentially between first connection tab 50 and second connection tab 50 and longitudinally between annular portion 47 of connection flange 46 and inner annular wall 44 of exhaust cone 40. For this purpose, external sealing wall 71 has a generally trapezoidal shape which is coincident with the trapezoidal shape of the sealed-off space.

External plate 70 further comprises a first external side tab 76 and a second external side tab 77. First external side tab 76 and second external side tab 77 extend circumferentially respectively from a first circumferential end and a second circumferential end of external sealing wall 71. The first circumferential end and the second circumferential end of external sealing wall 71 are circumferentially opposite one another. First external side tab 76 and second external side tab 77 are each applied in the radial direction respectively against the radially outer face of first connection tab 50 and the radially inner face of second connection tab 50. In the example illustrated, first external side tab 76 and second external side tab 77 have a dimension in the longitudinal direction that is identical to that of external sealing wall 71, i.e. identical to that of the sealed-off space.

External plate 70 also comprises an external upstream tab 78. External upstream tab 78 extends longitudinally upstream from external sealing wall 71. External upstream tab 78 is applied in the radial direction against longitudinal annular wall 49 of connection flange 46. During operation of the turbine engine, the pressure of the hot gases circulating in the turbine engine is higher radially externally to the assembly than radially internally. In other words, the pressure is higher radially externally to connection tabs 50 and inner annular wall 44 than within the volume defined radially internally to connection tabs 50 and inner annular wall 44. Thus, due to this pressure difference, a radially inward force is exerted on external plate 70 of each sealing member 60. External plate 70 is thus pressed against the radially outer face of first connection tab 50, second connection tab 50, and longitudinal annular wall 49 of connection flange 46 by the abutment of tabs 76, 77, 78. This thus allows better sealing of the corresponding free space.

Sealing member 60 also comprises an internal plate 80. Internal plate 80 may be made of metal. Internal plate 80 is connected to external plate 70. Internal plate 80 comprises an internal sealing wall 81. Internal sealing wall 81 is arranged circumferentially between first connection tab 50 and second connection tab 50. Internal sealing wall 81 therefore also contributes to sealing closed the free space formed circumferentially between first connection tab 50 and second connection tab 50 and longitudinally between annular portion 47 of connection flange 46 and the annular wall of exhaust cone 40. Internal sealing wall 81 has, for this purpose, a generally trapezoidal shape which is coincident with the trapezoidal shape of the sealed-off space. Internal plate 80 further comprises an internal downstream tab 88 which extends downstream longitudinally from internal sealing wall 81.

In this embodiment, sealing member 60 comprises a seal 90. Seal 90 may be made of a material resistant to high temperatures. In another configuration, seal 90 comprises a first portion 91 which is interposed in the radial direction, preferably clamped, between internal downstream tab 88 and a radially inner face of inner annular wall 44 of exhaust cone 40. This allows improving the radial sealing between sealing member 60 and inner annular wall 44 of exhaust cone 40. In addition, a simple radial abutment of first portion 91 of seal 90 against inner annular wall 44 of exhaust cone 40 reduces, or even prevents, the generation of mechanical stresses in inner annular wall 44 of exhaust cone 40. This reduces, or even prevents, the risk of damage to inner annular wall 44. The first portion of the seal may be held in place by a retainer which is part of or is fixed to plate 70. First portion 91 of seal 90 here is coincident with a downstream end portion of seal 90.

Seal 90 also comprises a second portion 92. Second portion 92 is different from first portion 91. Second portion 92 of seal 90 is arranged radially between external sealing wall 71 and internal sealing wall 81. Such an arrangement allows seal 90 to be fixed to external plate 70 and internal plate 80. Second portion 92 of seal 90 is generally flat. Second portion 92 of seal 90 comprises three holes 101 adapted to allow a connecting means 100 to pass through between external sealing wall 71 and internal sealing wall 81. Here, connecting means 100 between internal plate 80 and external plate 70 is a rivet type of mechanical means.

In the case of the first embodiment, second portion 92 of seal 90 extends circumferentially from first connection tab 50 to second connection tab 50 and longitudinally from annular portion 47 of connection flange 46 to an upstream end portion of inner annular wall 44 of exhaust cone 40.

Seal 90 comprises a first external side tab 93 and a second external side tab 94 which each extend circumferentially respectively from a first circumferential end and a second circumferential end of second portion 92 of seal 90. The first circumferential end and the second circumferential end of second portion 92 of seal 90 are circumferentially opposite one another. First external side tab 93 of seal 90 is radially clamped between first connection tab 50 and first external side tab 76 of external plate 70. Second external side tab 94 of seal 90 is radially clamped between second connection tab 50 and second external side tab 77 of external plate 70. This allows improving the sealing circumferentially between sealing member 60 and each among first connection tab 50 and second connection tab. In the illustrated example, the first side tab and the second side tab have a dimension in the longitudinal direction that is identical to that of external plate 70, i.e. identical to that of the sealed-off space.

Similarly, seal 90 comprises an external upstream tab 95 which extends longitudinally from an upstream end of second portion 92 of seal 90. External upstream tab 95 of seal 90 is clamped radially between longitudinal annular wall 49 of connection flange 46 and external upstream tab 95 of external plate 70. This allows improving the sealing longitudinally between sealing member 60 and connection flange 46.

Thus, in the first embodiment, the sealing relative to connection flange 46, first connection tab 50, and second connection tab 50 is improved by radially clamping tabs 93, 94, 95 of seal 90 between tabs 76, 77, 78 of external plate 70 on the one hand, and connection flange 46, first connection tab 50, and second connection tab 50 on the other hand.

Internal plate 80 further comprises a first internal side tab 86 and a second internal side tab 87. First internal side tab 86 and second internal side tab 87 respectively extend circumferentially from a first circumferential end and a second circumferential end of internal sealing wall 81. The first circumferential end and the second circumferential end of internal sealing wall 81 are circumferentially opposite one another. First internal side tab 86 and second internal side tab 87 are each applied, in the radial direction, respectively against a radially inner face of first connection tab 50 and a radially inner face of second connection tab 50. Due to the attachment of external plate 70 to internal plate 80, such an arrangement of internal side tabs 86, 87 allows increasing the clamping of each external side tab 93, 94 of seal 90 between the corresponding connection tab 50 and the corresponding external side tab 76, 77. This allows further improving the sealing produced by sealing member 60.

Each sealing member 60 may in particular be without any attachment relative to the corresponding first and second connection tabs 50. This allows giving a freedom of movement of sealing member 60 relative to first connection tab 50 and to second connection tab 50 when the two tabs thermally expand during operation of the turbine engine. This allows the stresses induced in the connection tabs to be reduced or even eliminated. Alternatively, external upstream tab 78 may be connected to annular portion 47 of connection flange 46 by mechanical means (screwing, welding in particular).

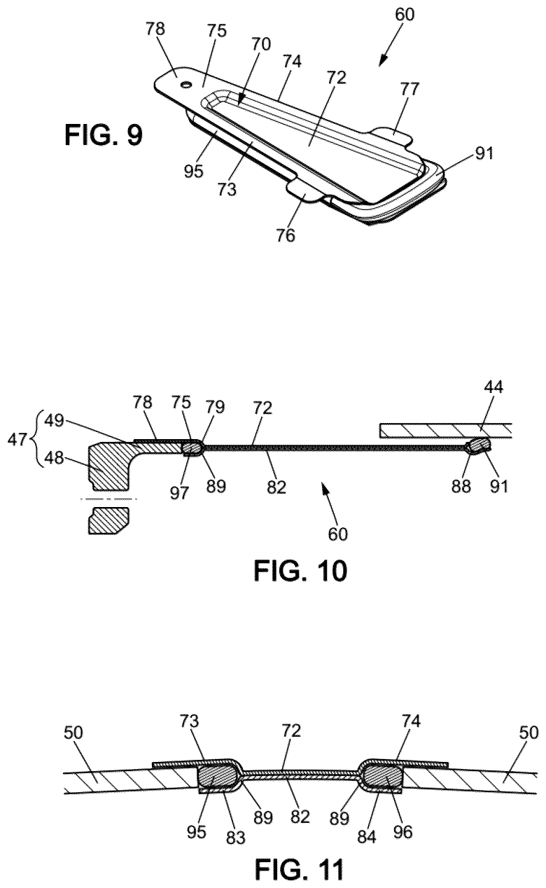

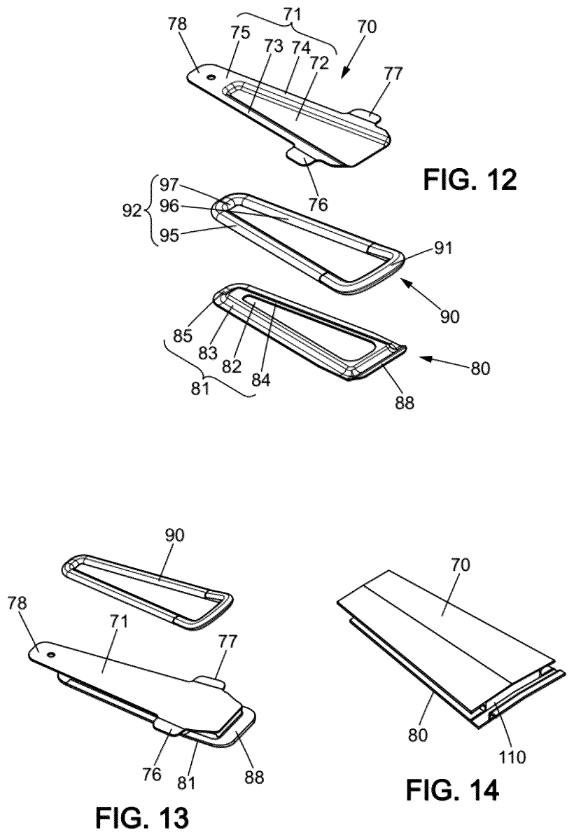

A second embodiment of sealing member 60 is now described with reference to FIGS. 9 to 12.

Sealing member 60 according to the second embodiment differs from the first embodiment in that external sealing wall 71 and internal sealing wall 81 each comprise a central portion 72, 82, an upstream end portion 75, 85, a first circumferential end portion 73, 83, and a second circumferential end portion 74, 84. First circumferential end portion 73, 83 and second circumferential end portion 74, 84 of each sealing wall 71, 81 are opposite each other in the circumferential direction relative to central portion 72, 82. In other words, central portion 72, 82 of each sealing wall 71, 81 is arranged circumferentially between the respective first circumferential end portion 73, 83 and second circumferential end portion 74, 84. “Upstream end portion” is also understood to refer to a portion arranged longitudinally upstream of the respective central portion 72, 82. In the present case, upstream end portion 75, 85 of each sealing wall 71, 81 is connected to and arranged upstream of the respective first circumferential end portion 73, 83 and second circumferential end portion 74, 84.

Central portion 72 of external sealing wall 71 bears radially against central portion 82 of internal sealing wall 81.

Thus, external sealing wall 71 and internal sealing wall 81 cooperate to form a first radial face and a second radial face. In the current case, the first radial face is formed by a radial shoulder 79 connecting central portion 72 of external sealing wall 71 to first circumferential end portion 73 of external sealing wall 71 and by a radial shoulder 89 connecting central portion 82 of internal sealing wall 81 to first circumferential end portion 83 of internal sealing wall 81. Similarly, the second radial face is formed by a radial shoulder 79 connecting central portion 72 of external sealing wall 71 to second circumferential end portion 74 of external sealing wall 71 and by a radial shoulder 89 connecting central portion 82 of internal sealing wall 81 to second circumferential end portion 84 of internal sealing wall 81. The first radial face and the second radial face are therefore circumferentially opposite one another.

Also, external sealing wall 71 and internal sealing wall 81 cooperate to form an upstream radial face. The upstream radial face is formed by a radial shoulder 79 connecting central portion 72 of external sealing wall 71 to upstream end portion 75 of external sealing wall 71 and by a radial shoulder 89 connecting central portion 82 of internal sealing wall 81 to upstream end portion 85 of internal sealing wall 81.

Sealing member 60 according to the second embodiment also differs from the first embodiment in that second portion 92 of seal 90 comprises a first side arm 95, a second side arm 96, and an upstream arm 97. First side arm 95 and second side arm 96 are each at a downstream end connected to first portion 91 of seal 90 and at an upstream end connected to upstream arm 97. First portion 91 of seal 90 comprises (in this case, forms) a downstream arm of seal 90. It is thus noteworthy that seal 90 is a peripheral seal.

First side arm 95 of seal 90 is clamped in the circumferential direction between the first radial face and first connection tab 50. This allows improving the sealing circumferentially between sealing member 60 and first connection tab 50. First side arm 95 is also arranged radially between first circumferential end portion 73 of external sealing wall 71 and first circumferential end portion 83 of internal sealing wall 81. Second side arm 96 of seal 90 is clamped radially in the circumferential direction between the second radial face and second connection tab 50. This allows improving the sealing circumferentially between sealing member 60 and second connection tab 50. Second side arm 96 is also arranged radially between second circumferential end portion 74 of external sealing wall 71 and second circumferential end portion 84 of internal sealing wall 81.

Upstream arm 97 is clamped in the longitudinal direction between the upstream radial face and longitudinal annular wall 49 of connection flange 46. This allows improving the sealing longitudinally between sealing member 60 and longitudinal annular wall 49 of connection flange 46. Upstream arm 97 of seal 90 is also arranged radially between upstream end portion 75 of external sealing wall 71 and upstream end portion 85 of internal sealing wall 81. It is thus noteworthy that seal 90 surrounds central portion 72, 82 of each among external sealing wall 71 and internal sealing wall 82.

Thus, in the second embodiment, the sealing relative to connection flange 46, first connection tab 50, and second connection tab 50 is ensured by a circumferential clamping of arms 95, 96, 97 of seal 90 between internal plate 70 and external plate 80 on the one hand, and connection flange 46, first connection tab 50, and second connection tab 50 on the other hand.

Finally, central portion 72 of external sealing wall 71 and central portion 82 of internal sealing wall 81 are connected to each other by mechanical means. The mechanical means may be welding, or a screw/nut or rivet attachment.

Also, it is noteworthy in the second embodiment that first external side tab 76 and second external side tab 77 have a dimension in the longitudinal direction that is less than that of external sealing wall 71, i.e. less than that of the sealed-off space.

According to an alternative embodiment of sealing member 60 of the second embodiment, shown in FIG. 13, central portion 72 of external sealing wall 71 and central portion 82 of internal sealing wall 81 are connected to each other by a one-piece connection. One-piece connection is understood to mean that central portion 72 of external sealing wall 71 and central portion 82 of internal sealing wall 81 are formed as an integral unit. External plate 70 and internal plate 80 therefore form a unit assembly.

According to another variant embodiment of sealing member 60 of the second embodiment, shown in FIG. 14, external sealing wall 71 and internal sealing wall 81 are connected by an intermediate connection part 110 arranged radially between internal sealing wall 81 and external sealing wall 71. The first radial face, the second radial face, and the upstream radial face are formed by intermediate connection part 110. External sealing wall 71 and internal sealing wall 81 may be connected to intermediate connection part 110 by mechanical means or by a one-piece connection.

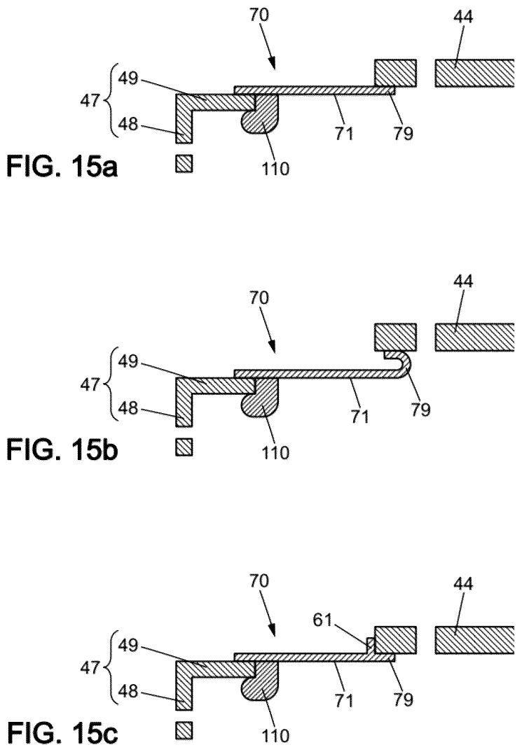

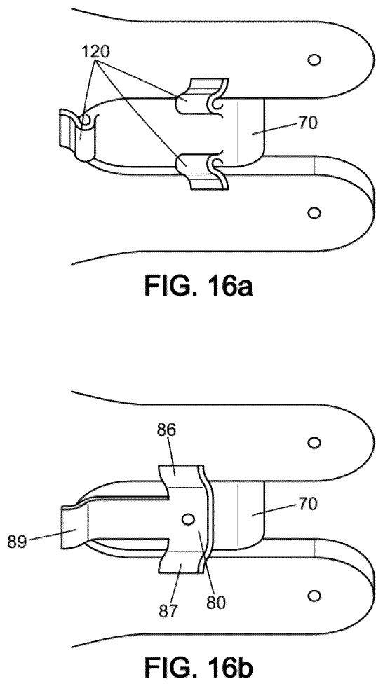

A third embodiment of sealing member 60 is now described with reference to FIGS. 15 and 16. According to the third embodiment, sealing member 60 is without a seal.

External plate 70 may comprise an external upstream tab, a first external side tab, and/or a second external side tab as described with reference to the first embodiment.

As can be seen in FIG. 15, external plate 70 here comprises an external downstream tab 79 which extends longitudinally downstream from external sealing wall 71. External downstream tab 79 is applied radially externally against inner annular wall 44 of exhaust cone 40. Alternatively, external downstream tab 79 may be, in whole or in part, applied radially internally against inner annular wall 44 of exhaust cone 40. The radial abutment between external downstream tab 79 and inner annular wall 44 ensures the seal between sealing member 60 and inner annular wall 44 of exhaust cone 40.

According to the variant in FIG. 15a, external downstream tab 79 is straight or in other words flat. According to the variant in FIG. 15b, external downstream tab 79 curves into a radially outward and longitudinally upstream fold relative to the external sealing wall. In other words, the external downstream tab is curved radially outwards and longitudinally upstream. This allows improving the sealing between the sealing member and the annular wall of the exhaust cone.

According to the variant in FIG. 15c, external plate 70 comprises a radial lip 61 which extends radially outward from external sealing wall 71. Radial strut 61 is bearing in the longitudinal direction against an upstream end of inner annular wall 44 of exhaust cone 40. This allows improving the sealing between sealing member 60 and inner annular wall 44 of exhaust cone 40.

As shown in FIG. 16a, external plate 70 may comprise one or more hooks 120 for connecting to connection flange 46 and/or to adjacent connection tabs 50 and for improving the sealing. Each hook 120 is radially connected to the inside of external plate 70. Here, external plate 70 comprises an upstream hook 120 engaged with annular portion 47 of connection flange 46, in particular with longitudinal annular wall 49. External plate 70 also comprises two side hooks 120, each side hook 120 being engaged with one of the adjacent connection tabs 50. Thus, annular portion 47 of connection flange 46 and connection tabs 50 are pinched between the respective hook 120 and the external plate. Each hook 120 may be elastic.

Alternatively, according to the variant in FIG. 16b, the sealing member may comprise an internal plate 80 secured to external plate 70. The internal plate comprises one or more tabs for connecting external plate 70 to connection flange 46 and/or to adjacent connection tabs 50. Internal plate 80 here comprises an internal upstream tab 89, longitudinal annular wall 49 of annular portion 47 of connection flange 46 being interposed radially between external upstream tab 78 and internal upstream tab 89. In other words, internal upstream tab 89 may be applied radially against the radially inner face of longitudinal annular wall 49 of annular portion 47 of connection flange 46. Internal plate 80 also comprises a first internal side tab 86 and a second internal side tab 87 which are circumferentially opposite one another. First connection tab 50 may be radially interposed between first external side tab 76 and first internal side tab 86. Second connection tab 50 may be radially interposed between second external side tab 77 and second internal side tab 87. In other words, first internal side tab 86 and second internal side tab 87 may respectively be applied radially to the radially inner face of first connection tab 50 and second connection tab 50.

Internal plate 70 and external plate 80 may be connected to each other by mechanical means or by a one-piece connection. One-piece connection is understood to mean that internal plate 70 and external plate 80 may be formed as an integral unit. For example, internal plate 70 and external plate 80 may be made in one piece by additive manufacturing. External plate 70 and internal plate 80 may thus form a unit assembly. The mechanical means may be welding, or a screw/nut or rivet attachment.

1. An assembly for a turbine engine having a longitudinal axis (X), comprising:
an exhaust cone (40) comprising an annular wall (44),
an exhaust casing arranged upstream of the exhaust cone (40),
a connection flange (46) arranged longitudinally between the exhaust casing and the exhaust cone (40), the connection flange (46) comprising:
an annular portion (47) which is fixed to the exhaust casing, and
connection tabs (50) extending longitudinally downstream from the annular portion, the connection tabs (50) being distributed circumferentially around the longitudinal axis (X), each connection tab (50) being connected to the annular wall (44) of the exhaust cone (40), and
a plurality of sealing members (60), each sealing member (60) sealing closed a space circumferentially delimited between a first connection tab (50) and a second connection tab (50) which are circumferentially successive and longitudinally delimited between the annular portion (47) of the connection flange (46) and the annular wall (44) of the exhaust cone (40), each sealing member (60) comprising an external plate (70) adapted to be partly applied in the radial direction against a radially outer face of each among the first connection tab (50) and second connection tab (50).

2. The assembly according to claim 1, wherein the external plate (70) comprises:
an external sealing wall (71),
a first external side tab (76), and
a second external side tab (77), the external sealing wall (71) being arranged circumferentially between the first and second connection tabs (50), the first external side tab (76) and the second external side tab (77) respectively extending circumferentially from a first circumferential end and a second circumferential end of the external sealing wall (71) which are circumferentially opposite one another, the first external side tab (76) and the second external side tab (77) each being, in whole or in part, applied in the radial direction respectively against the radially outer face of the first connection tab (50) and the radially outer face of the second connection tab (50).

3. The assembly according to claim 2, wherein the external plate (70) comprises an external upstream tab (78) which extends longitudinally upstream from the external sealing wall (71), the external upstream tab (78) being applied, in whole or in part, in the radial direction against the annular portion (47) of the connection flange (46).

4. The assembly according to claim 2, wherein each sealing member (60) comprises an internal plate (80), the internal plate (80) being connected to the external plate (70), the internal plate (80) comprising an internal sealing wall (81) arranged circumferentially between the first connection tab (50) and the second connection tab (50), and an internal downstream tab (88) which extends longitudinally downstream from the internal sealing wall (81).

5. The assembly according to claim 4, wherein each sealing member (60) comprises a seal (90), the seal (90) bearing against the annular wall (44) of the exhaust cone (40).

6. The assembly according to claim 5, wherein the seal (90) comprises at least a first portion (91) which is positioned in the radial direction between the internal downstream tab (88) of the internal plate (80) and the annular wall (44) of the exhaust cone (40).

7. The assembly according to claim 6, wherein the seal (90) comprises a second portion (92) that is different from the first portion (91), the second portion (92) of the seal (90) being arranged radially between the external sealing wall (71) and the internal sealing wall (81).

8. The assembly according to claim 7, wherein the second portion (92) of the seal (90) extends circumferentially from the first connection tab (50) to the second connection tab (50) and longitudinally from the annular portion (47) of the connection flange (46) to an upstream end portion of the annular wall (44) of the exhaust cone (40).

9. The assembly according to claim 7, wherein the seal (90) comprises a first external side tab (93) and a second external side tab (94) which each extend circumferentially from a respective first circumferential end and second circumferential end of the second portion (92) of the seal (90) which are opposite one another, the first external side tab (93) of the seal being positioned radially between the first connection tab (50) and the first external side tab (76) of the external plate (70), and the second external side tab (94) of the seal (90) being positioned radially between the second connection tab (50) and the second external side tab (77) of the external plate (70).

10. The assembly according to claim 7, wherein the external sealing wall (71) and the internal sealing wall (81) cooperate to form a first radial face and a second radial face, and wherein the second portion (92) of the seal (90) comprises a first side arm (96) and a second side arm (96) each being connected at a downstream end to the first portion (91) of the seal (90), the first side arm (95) of the seal (90) being positioned in the circumferential direction between the first radial face and the first connection tab (50) and the second side arm (96) of the seal (90) being positioned in the circumferential direction between the second radial face and the second connection tab (50).

11. The assembly according to claim 10, wherein the external sealing wall (71) and the internal sealing wall (81) cooperate to form an upstream radial face, and wherein the second portion (92) of the seal (90) comprises an upstream arm (97), the first side arm (95) and the second side arm (96) each being connected at an upstream end to the upstream arm (97), the upstream arm (97) of the second portion (92) of the seal (90) being positioned in the longitudinal direction between the upstream radial face and the annular portion (47) of the connection flange (46).

12. The assembly according to claim 1, wherein each sealing member (60) comprises a seal (90), the seal (90) bearing against the annular wall (44) of the exhaust cone (40).
